(19) United States
(12) Patent Application Publication
(10) Pub. No.: US 2021/0104720 A1
(43) Pub. Date: Apr. 8, 2021

(54) ELECTRODE MATERIALS COMPRISING COLD SPRAY DOPED COMPOSITIONS

(71) Applicant: SOUTH DAKOTA BOARD OF REGENTS, Pierre, SD (US)

(72) Inventors: HAIPING HONG, RAPID CITY, SD (US); ROB HRABE, RAPID CITY, SD (US)

(21) Appl. No.: 16/948,998

(22) Filed: Oct. 8, 2020

Related U.S. Application Data
(60) Provisional application No. 62/912,090, filed on Oct. 8, 2019.

(51) Int. Cl. H01M 4/04; H01M 4/38; H01M 10/0525

(52) U.S. Cl. CPC H01M 4/0419; H01M 10/0525; H01M 4/386

(57) ABSTRACT

The present disclosure relates to methods, and the resultant compositions, of preparing doped electrode materials comprising doping electrode compositions via a cold spray method. Preferably, the electrode materials are doped with hetero atoms and/or silicon-based compounds. The doped electrode materials preferably have a well-distributed deposition of the hetero atoms and/or silicon-based compounds.

### CROSS-REFERENCE

This application is related to and claims priority under 35 U.S.C. § 119 to U.S. Provisional Application Ser. No. 62/912,090 filed on Oct. 8, 2019 and entitled “ELECTRODE MATERIALS COMPRISING COLD SPRAY DOPED COMPOSITIONS”; the entire contents of this patent application are hereby expressly incorporated herein by reference.

### GRANT REFERENCE

This invention was made with government support under Grant No. FA864920P0990 and Grant No. FA864920P0398, each awarded by the United States Air Force. The Government has certain rights in the invention.

### TECHNICAL FIELD

The present disclosure relates to methods, and the resultant compositions, of preparing doped electrode materials comprising doping electrode compositions via a cold spray method. Preferably, the electrode materials are doped with hetero atoms and/or silicon-based compounds.

### BACKGROUND

Lithium-ion batteries have been extensively studied in the scientific community because of their high power and high energy density. The potential applications in these energy storage devices have attracted much attention. In order to increase the energy density of lithium ion batteries, exploring advanced electrode materials is a worth direction, especially for anode materials. It is meaningful to find a suitable electrode material that can improve the lithium insertion amount of the lithium ion battery and the reversibility of lithium insertion and deintercalation. The replacement of metallic lithium by carbon material successfully solves the safety problem caused by the formation of lithium dendrites during charging and discharging process in lithium ion batteries and can achieve reversible efforts. At the same time, the carbon material after replacing lithium metal greatly reduced the energy density of the battery since the electrochemical specific capacity of metallic lithium is about 3860 mAhg⁻¹, while the electrochemical specific capacity of graphite is only about 372 mAhg⁻¹.

Silicon alloy is a well-known anode material, but conventional manufacturing methods cause the oxidation of the silicon element. A difficulty in preparing such materials has been that preferred techniques are unavailable or those which are available often result in changes to the underlying electrode materials such as the carbon materials or electrochemically active components added (e.g., silicon compounds or hetero atoms). For example, chemical vapor deposition requires a sufficiently low melting point, which many silicon alloys do not have. Other techniques often result in oxidation of the ingredients. Accordingly, there is a need for techniques capable of preparing electrode compositions with improved properties.

### BRIEF SUMMARY OF THE PREFERRED EMBODIMENTS

An advantage of the invention is that the methods described herein provide improved electrode compositions. It is an advantage of the present invention that the methods of preparing electrode compositions disclosed herein are improved over existing methods of preparing electrode compositions. Moreover, the electrode compositions themselves have unexpectedly improved properties.

A preferred embodiment comprises a method of preparing an electrode material comprising depositing a doping material onto an electrode material; wherein the depositing is performed by cold spray and wherein the cold spray comprises a carrier gas; and wherein the doping material comprises hetero atoms, a silicon-based compound, or a mixture thereof.

A preferred embodiment comprises an electrode material doped, via cold spray, with hetero atoms, a silicon-based compound, or a mixture thereof

A preferred embodiment comprises a battery comprising one or more electrodes which have been doped, via cold spray, with hetero atoms, a silicon-based compound, or a mixture thereof.

While multiple embodiments are disclosed, still other embodiments of the present invention will become apparent to those skilled in the art from the following detailed description, which shows and describes illustrative embodiments of the invention. Accordingly, the figures and detailed description are to be regarded as illustrative in nature and not restrictive.

### BRIEF DESCRIPTION OF THE FIGURES

The patent or application file contains at least one figure executed in color. Copies of this patent or patent application publication with color drawing(s) will be provided by the Office upon request and payment of the necessary fee.

FIG. 1A shows an X-ray diffraction (XRD) pattern of the SNCNT material prepared in Example 1.

FIG. 1B shows a Raman spectra of the SNCNT material prepared in the Example.

FIG. 2A shows an X-ray photoelectron spectroscopy (XPS) survey scan spectrum of the SNCNT material prepared in Example 1.

FIG. 2B shows a high-resolution XPS spectra with Gaussian fitting of Si2p of the SNCNT material corresponding to the XPS survey scan spectrum of FIG. 2A.

FIG. 2C shows a high-resolution XPS spectra with Gaussian fitting of C1s of the SNCNT material corresponding to the XPS survey scan spectrum of FIG. 2A.

FIG. 2D shows a high-resolution XPS spectra with Gaussian fitting of N1s of the SNCNT material corresponding to the XPS survey scan spectrum of FIG. 2A.

FIG. 3A shows a scanning electron microscope (SEM) image of the SNCNT material prepared in Example 1 to examine the morphology of the SNCNT material.

FIG. 3B shows a scanning electron microscope (SEM) image of the SNCNT material prepared in Example 1 to examine the morphology of the SNCNT material.

FIG. 3C shows a scanning electron microscope (SEM) image of the SNCNT material prepared in Example 1 to examine the morphology of the SNCNT material.

FIG. 3D shows an energy dispersive x-ray spectroscopy (EDX) image of the SNCNT material of FIGS. 3A-3B of both the carbon nanotubes and the silicon materials. The carbon nanotubes are darker grey and the silicon particles appear light grey to white.

FIG. 3E shows an energy dispersive x-ray spectroscopy (EDX) image of the SNCNT material of FIGS. 3A-3B of carbon. The carbon appears light grey to white.

FIG. 3F shows an energy dispersive x-ray spectroscopy (EDX) image of the SNCNT material of FIGS. 3A-3B of silicon. The silicon appears light grey to white.

FIG. 4A shows a color cyclic voltammetry curve at 0.1 mVs⁻¹ scan rate of the SNCNT material prepared in Example 1.

FIG. 4B shows color Galvanostatic charge-discharge profiles at a current density of 100 mAg⁻¹ of the SNCNT material prepared in Example 1.

FIG. 4C shows a graph evaluating the cycling performance of the SNCNT material prepared in Example 1 at a current density of 100 mAg⁻¹.

FIG. 4D shows a graph evaluating the rate performance of the SNCNT material prepared in Example 1 at various current densities.

FIG. 5A shows a color differential capacity plot of the SNCNT material prepared in Example 1 at a current density of 100 mAg⁻¹.

FIG. 5B shows Nyquist plots of the SNCNT material prepared in Example 1 at voltages of 0.1V, 0.3V, 0.5V, 1.0V, 1.35V, 1.50V, 2.0V, 2.5V, and 3.0V.

FIG. 6A shows optical microscope images of the four sample anode materials prepared in Example 2.

FIG. 6B shows scanning electron microscope images of the four sample anode materials prepared in Example 2.

FIG. 7 shows color elemental dispersal images taken by energy dispersive x-ray (EDX) of the four sample anode materials prepared in Example 2; tin is shown in green, iron in orange, manganese in yellow, silicon in pink, and aluminum in blue.

FIG. 8A shows a spectra of elements deposited in Sample 001 of Example 2 on a weight percentage basis.

FIG. 8B shows a spectra of elements deposited in Sample 002 of Example 2 on a weight percentage basis.

FIG. 8C shows a spectra of elements deposited in Sample 003 of Example 2 on a weight percentage basis.

FIG. 8D shows a spectra of elements deposited in Sample 004 of Example 2 on a weight percentage basis.

The figures described herein form part of the specification and are included to further demonstrate certain preferred embodiments aspects of the invention. In some instances, embodiments of the invention can be best understood by referring to the accompanying figures in combination with the detailed description presented herein. The description and accompanying figures may highlight a certain specific example, or a certain aspect of the invention. However, one skilled in the art will understand that portions of the example or aspect may be used in combination with other examples or aspects of the invention.

### DETAILED DESCRIPTION OF THE PREFERRED EMBODIMENTS

The present invention relates to electrode materials comprising cold spray doped compositions. Preferably, the cold spray doped compositions are doped with hetero atoms and/or silicon-based compounds.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

The term “about,” as used herein, refers to variation in the numerical quantity that can occur, for example, through typical measuring techniques and equipment, with respect to any quantifiable variable, including, but not limited to, concentration, mass, volume, pressure, time, temperature, distance, voltage, capacity, and current. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “functionalized,” as used herein, refers to a molecule having a certain functional group.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

References to elements herein are intended to encompass any or all of their oxidative states and isotopes. For example discussion of aluminum can include Al^{I}, Al^{II}, or Al^{III} and references to boron include any of its isotopes, i.e., ⁶B, ⁷B, ⁸B, ⁹B, ¹⁰B, ¹¹B, ¹²B, ¹³B, ¹⁴B, ¹⁵B, ¹⁶B, ¹⁷B, ¹⁸B, and ¹⁹B.

### Doped Electrode Materials

The methods described herein, and as exemplified in the Examples section, provide for electrode materials which can be doped with hetero atoms and/or silicon-based compounds, including but not limited to, silicon, silicon oxides and silicon alloys. Beneficially, the methods described herein can be used to additively consolidate active materials and metal binder powders into electrode materials. This approach eliminates the need for solvent drying or calendaring and can be implemented directly on existing roll-to-roll manufacturing lines or can be used to truly 3D print electrodes into any shape or compositional structure. Benefits from this technique can include, but are not limited to, (1) less expensive electrode fabrication, (2) Increased flexibility in manufacturing, (3) reduced environmental impact, and (4) ready incorporation with state-of-the-art battery materials. Further, the methods described herein can be used for a variety of battery technologies, including, but not limited to lithium-ion and sodium-ion battery applications. Further, the methods described herein are suitable for preparation of both anode and cathodes by doping an electrode material with hetero atoms, silicon-based compounds, or a mixture thereof. As shown in the Examples, the deposited doping materials can be well-dispersed, more preferably homogenously dispersed, and can contain low oxygen content in the deposited material.

In an aspect of the disclosure, a doping material is acquired and/or optionally prepared. Preparation of the doping material can comprise dispersion of the doping material in a liquid medium. The doping material is preferably dispersed with the aid of surfactant and/or sonication or ultrasonication. The doping material is then deposited to an electrode material by a cold spray technique. Preferably, the amount of doping material deposited is in an amount between about 0.01 wt. % and about 10 wt. %, more preferably between about 0.1 wt. % and about 8 wt. %, most preferably between about 1 wt. % and about 5 wt. % based on the mass of the electrode material after deposition of the doping material. In a preferred embodiment, the cold spraying is performed under an inert gas or nitrogen. Preferred inert gases include, but are not limited to, helium and the noble gases. Most preferably, the inert gas is argon.

### Cold Spray Method

The methods of preparing the doped electrode materials comprise a step of performing cold spray on an electrode material to deposit silicon-based compounds, hetero atoms, or a mixture thereof. Preferably the depositing step is performed under an inert gas as described above. Preferred inert gases include the noble gases and helium. Most preferably, the inert gas is argon.

The cold spray method comprises a carrier gas. In a preferred embodiment, the carrier gas comprises a noble gas, helium, or nitrogen. Most preferably, the carrier gas is helium or nitrogen.

In a cold spray method, the carrier gas is at a pressure. In a preferred embodiment, the carrier gas is at a pressure between about 250 psi and about 900 psi. In a preferred embodiment, the carrier gas is at a pressure of at least about 250 psi, at least about 300 psi, at least about 350 psi, at least about 400 psi, at least about 450 psi, at least about 500 psi, at least about 525 psi.

In a cold spray method, the carrier gas is preferably at a temperature of between about 200° C. and about 900° C., more preferably between about 250° C. and about 800° C., still more preferably between about 275° C. and about 600° C., most preferably between about 300° C. and about 500° C.

In a preferred embodiment, the method of preparing the doped electrode materials can further comprise a step of dispersing the doping material. Preferably, such a dispersing step is performed before the depositing step. In a preferred embodiment, the dispersing step comprises mixing the doping material with a surfactant, sonicating the doping material in a liquid medium, or both.

Cold spray device specifications and parameters for use are disclosed in greater detail in U.S. Patent Publication Number US20140117109A1, which is hereby incorporated by reference.

### Doping Materials

Preferred doping materials include, but are not limited to, hetero atoms, silicon-based compounds, and mixtures thereof. Preferred hetero atoms include, but are not limited to, N, P, S, B, O, F, Cl, Br, I, and mixtures thereof. Preferred silicon-based compounds include, but are not limited to, Si, silicon oxides, silicon-alloys, and mixtures thereof. In an aspect of the invention, a mixture of metals and/or metalloids can be used to form an alloy upon deposition. This can occur to due the energy imparted on the metals and/or metalloids when they collide with the electrode material. For example, silicon and other metals can be mixed and deposited to an electrode material via cold spray thereby forming a silicon-based alloy on the surface of the electrode material. Preferred other metals include, but are not limited to, lanthanides (such as, lanthanum, cerium, praseodymium, neodymium, promethium, samarium, europium, gadolinium, terbium, dysprosium, holmium, erbium, thulium, ytterbium, and lutetium), gold, silver, copper, aluminum, cobalt, magnesium, zinc, vanadium, manganese, niobium, iron, nickel, titanium, zirconium, tin, other rare earth metals such as scandium and yttrium, and combinations and alloys of the aforementioned metals with each other and/or metal oxides.

In a preferred embodiment, the doping material once deposited has a low oxygen content. While oxygen is not intentionally deposited except as part of a silicon-based composition (e.g., silicon dioxide), it is expected that oxygen will be deposited due to oxidation of the silicon-based compounds and/or hetero atoms. Preferably, the deposited doping material has an oxygen content of less than about 10 wt. %, more preferably less than about 7 wt. %, still more preferably less than about 5 wt. %, even more preferably equal to or less than about 4.5%, most preferably less than about 4 wt. %. In an embodiment where the doping material comprises a silicon-based compound, the silicon deposited is preferably in an amount of at least about 15 wt. % of the deposited doping material, still more preferably at least about 20 wt. % of the deposited doping material, and most preferably at least about 25 wt. % of the deposited doping material.

### Surfactants

The doping materials can be combined with a surfactant. Preferably the surfactants comprise one or more of the following functional groups, sulfonate, phosphate, quaternary ammonium, —OH, —COOH, —NH₂, —SH₂, —PhSO₃Na, or a combination thereof.

### Electrode Materials

Any suitable electrode materials can be doped with the doping materials according to the methods described herein. In a preferred embodiment, the electrode materials are preferably useful for lithium-ion batteries or sodium-ion batteries. Suitable electrode materials can be anode materials and/or cathode materials. In a preferred embodiment, the electrode materials comprise carbon nanomaterials, including, but not limited to, carbon nanotubes (including C-SWNT and C-MWNT), carbon nanotube fiber (carbon nanotube yarn), carbon fibers, and combinations thereof. In addition to the common hexagonal structure, the cylinder of nanotube molecules can also contain other size rings, such as pentagon, heptagon, and octagon. Replacement of some regular hexagons with other ring structures, such as pentagons and/or heptagons, can cause cylinders to bend, twist, or change diameter, and thus lead to some interesting structures such as Y-, T-, and X-junctions, and different chemical activities. Those various structural variations and configurations can be found in both SWNT and MWNT. Carbon nanotubes can be in the configuration of armchair, zigzag, chiral, or combinations thereof. The nanotubes can also contain structural elements other than hexagon, such as pentagon, heptagon, octagon, or combinations thereof.

The electrode material can be added to a current collector and placed in any battery configuration. For example, a battery can comprise an anode, a cathode, and an electrolyte interposed between the anode and cathode. Preferably, the anode is in electrical contact with an anode current collected, and the cathode is in electrical contact with a cathode current collector.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

### Preparation and Characterization of Exemplary Hetero Atom-Doped Silicon Composites

### Preparation

SWNT were purchased from Cheap Tubes Inc. The surfactant Hexadecyltrimethylammonium bromide (CTAB) and Si nanoparticles were purchased from Sigma-Aldrich and used as received. Ultrasonication was performed with a Branson Model 450 Digital Sonifier with a ½″ disrupter horn. Initially, 3.75 g surfactant was first dispersed in deionized water of resistivity 18 MΩ-cm by using ultrasonication for 20 minutes until a clear solution was achieved. Then, 0.5 g SWNT was added to the solution and sonicated for an additional 20 minutes. Finally, 0.25 g Si nanoparticles were added to the mixture and sonicated for 40 minutes. After ultrasonication, the solution was filtered and dried inside a vacuum oven at 80° C. for 10 hours at a pressure of 15 inches of mercury.

Material characterization

Scanning electron microscopy (SEM) characterization was performed on a field emission HITACHI-SU8220 instrument and transmission electron microscope (TEM) images were captured on a JEOL-2010 instrument at an acceleration voltage of 200 kV. To reveal the transformation of the phase composition during the reaction, XRD analysis was carried out with Cu Kα radiation at λ=1.54182 Å on a Bruker D8 Advance Diffractometer. X-ray photoelectron spectroscopy (XPS) analysis was tested by an incident monochromatic X-ray beam from the Al target focused on the materials with a spot size of 900 um.

### Electrochemical Measurements

The working electrode was prepared by mixing the active material (SNCNT), acetylene black, and sodium carboxymethyl cellulose in a mass ratio of 6:3:1. 1 mol LiF6 solution in a 1:1:1 (volume) mixture of ethylene carbonate (EC), dimethyl carbonate (DMC) and ethyl methyl carbonate (EMC) was used as electrolyte. The working electrode was dried in vacuum oven for about 6 h and the loading active material of this electrode is around 1˜1.2 mg/cm². The electrochemical characterizations were conducted in 2025-type coin cells using Li foil (99.9%, China Energy Lithium Co., Ltd., Tianjin) as the counter electrode. Galvanostatic charge-discharge (GCD) experiments were conducted on a battery testing system (CT2001A, Land) over a range of 0.01-3 V vs. Li/Li+. Cyclic voltammetry (CV) measurements were performed on an electrochemical workstation within the range of 0-3 V. The reported specific capacities (SCs) are all normalized to the weight of active materials.

### Result and Discussion

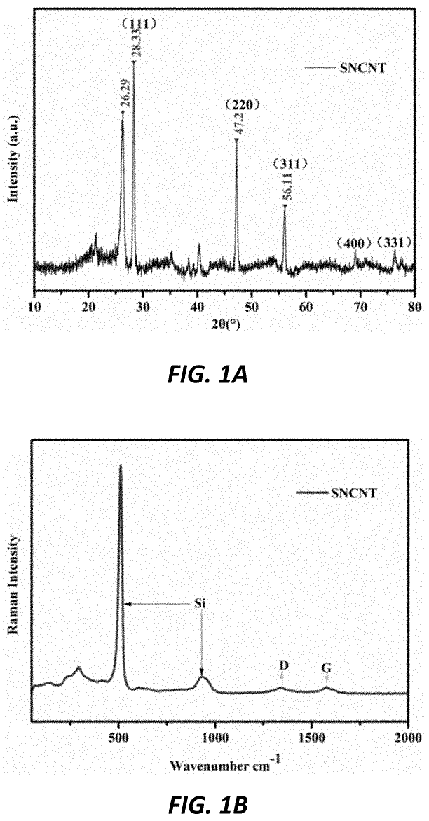

The prepared silicon-nitrogen-doped carbon nanotube composite was characterized by X-ray diffraction, and is shown in FIG. 1A. The peaks centered at 28.33°, 47.23°, 56.08°, 69.07° and 76.36°, corresponding to (111), (220), (311), (400) and (331) planes of Si lattice (PDF No. 27-1402), respectively. The diffraction peaks of Si in SNCNT were sharp and intense, indicating highly crystalline nature of Si. In the XRD diffraction curve of the SNCNT composite, no gentle peak is observed, which means that the material has perfect crystallinity. To further confirm the fine structure of silicon-nitrogen-doped carbon nanotube composites and the presence of silicon crystals, Raman spectra was acquired. As observed in FIG. 1B, the Raman spectroscopy suggests that the bare Si nanoparticles have a sharp characteristic peak centered at 511 cm⁻¹ and two weak peaks at 292.5 cm⁻¹ and 935 cm⁻¹, indicating the crystalline of Si. Raman spectroscopy is sensitive to subtle structural changes in carbon materials, especially for carbon nanotubes. The G peak at 1578 cm⁻¹ represents the first-order scattering Egg vibration mode, which is the in-plane optical vibration of the carbon atom of the sp² structure, and its peak intensity reflects the symmetry and order of the structure of the carbon nanotube. The D band identified at 1344.5 cm⁻¹ represents defects and disordered carbon, which is originated from a second-order process. Compared with the D-band peaks representing disordered carbon and defects, the peak intensity of the G band is slightly higher, indicating that the silicon-nitrogen-doped carbon nanotube composite has excellent structural symmetry and order. This also illustrates the integrity of the carbon nanotube structure from the side.

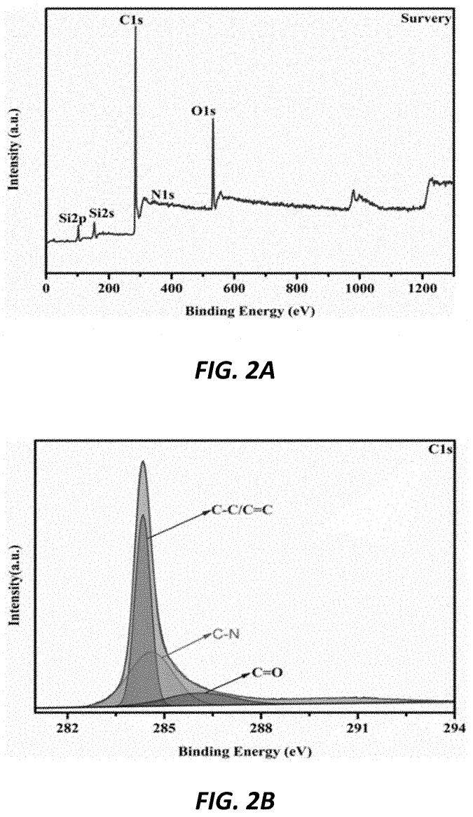

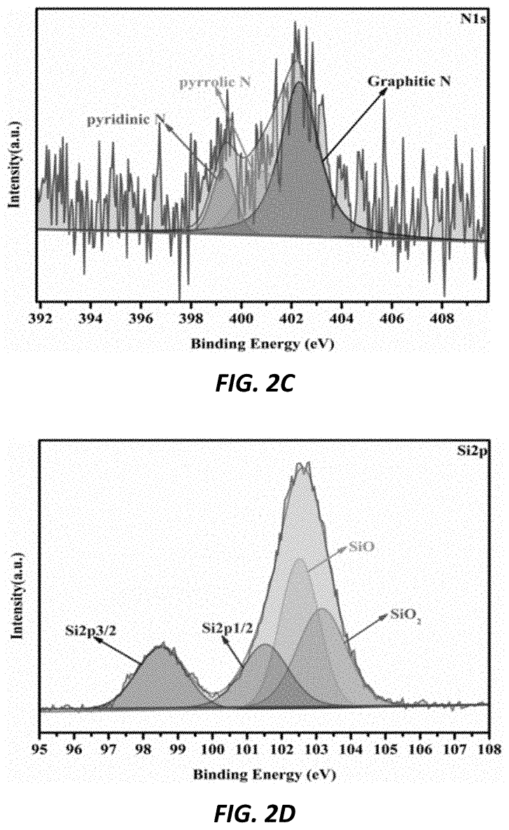

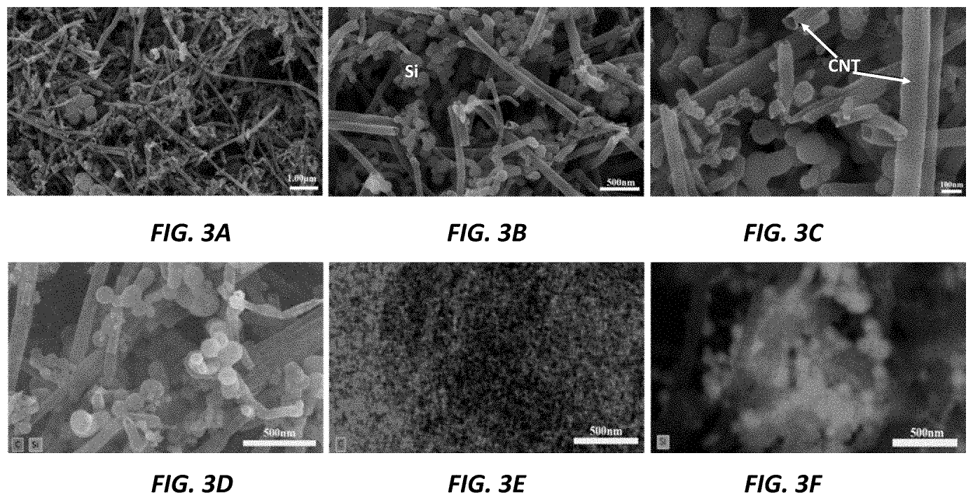

In the XPS measurement scan spectrum, the chemical states of the elements Si, C, N and O of the composite are further characterized as shown in FIG. 2A. The XPS curve of SNCNT is consisted by several peaks corresponding to the Si, C, N and O elements, while the N peak in the distribution is extremely weak but does exist. As illustrated in FIG. 2B, the C—C/C═C bond and the C═O bond center at 284.29 eV, 286.14 eV, respectively. The C—N bond is present at 284.59 eV, and its existence further confirms that the nitrogen atom is embedded in the carbon skeleton. The high-resolution N1s spectrum displayed in FIG. 2C could be fitted into various N states at approximately 400 eV which are consistent with the pyridinic, pyrrolic and graphitic pyridinic N, pyrrolic N and Graphitic N peaks, indicating the successful doping of nitrogen. N-doping can greatly improve the electrochemical performance, because the doped nitrogen atoms can produce more defects and active sites in the SNCNT composite, which leads to more convenient lithium ion transport channels being provided. Pyridine N has a strong electrochemical activity because the lone pair electrons are easily conjugated to the carbon p-ring, and pyrrole N can improve electron transfer, allowing electrons to be packed at different levels of the energy band. In addition, Graphite N increases the electrical conductivity of the composite by providing additional electrons. In other words, Graphite N can increase the electrical conductivity of SNCNT composites, while pyrrole and pyridine N in SNCNT composites can improve the storage of lithium ions. As depicted in the FIG. 2D, Si2p spectrum, the peaks at 98.49 and 101.49 eV are identified as Si—Si bonds, while the ones at 102.49 and 103.24 eV correspond to SiO and SiO₂. For pure carbon nanotubes, the charge per carbon atom is zero. When silicon atoms are doped into carbon nanotubes, the charge distribution on the carbon nanotubes is redistributed due to the difference in electronegativity between the silicon atoms and the carbon atoms.

The morphology and structure of SNCNT composites were characterized by SEM. As shown in FIGS. 2B and 2C, the Si nanoparticles constitute a unique microspherical structure that is distributed around the periphery of the carbon nanotubes. The volume expansion of the Si nanoparticles cannot cause the structure of the entire composite to collapse, resulting in a significant improvement in the cycle stability of the SNCNT composite electrode material. Furthermore, energy dispersive X-ray spectroscopy (EDX) mapping image, shown in FIG. 2D, demonstrates that the Si elements are homogeneously distributed around the carbon nanotubes, indicating that Si is successfully introduced into the composite. From the EDX results, the nitrogen content is extremely low, which is also good. High N doping levels could cause more defects in the composite and lead to structural instability.

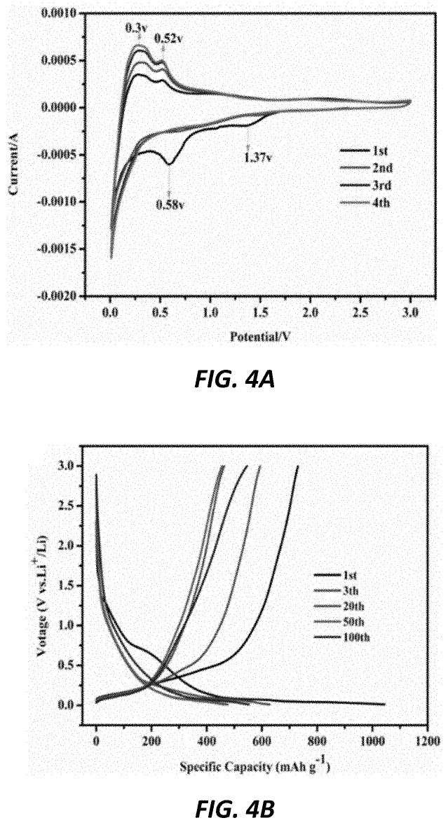

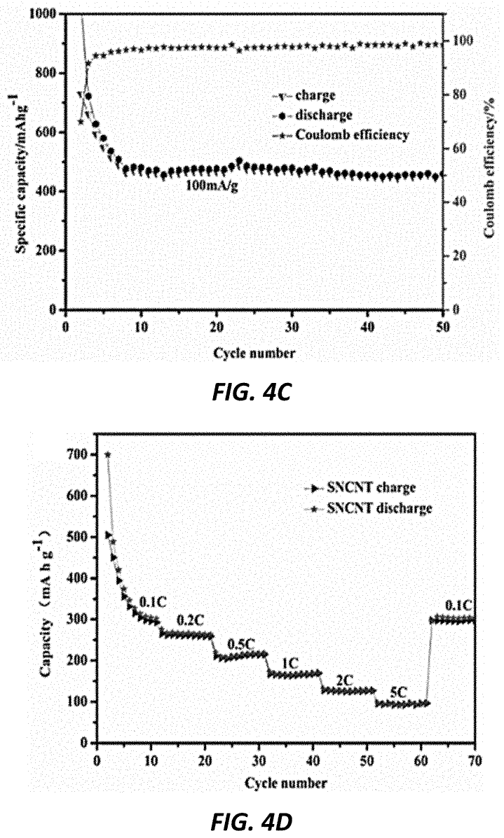

The first four cyclic voltammogram (CV) curves of the SNCNT composite electrode at room temperature between 0.0 and 3.0 V at a scan rate of 0.1 mVs⁻¹ are shown in FIG. 4A. It is clearly seen that the CV curve of the first cycle is different from the CV curve of the subsequent cycle, especially for the discharge brand. There is a main cathode peak at 0.58V, which corresponds to the lithiation reaction of Si to form a LiₓSi alloy. In the first cycle, two distinctly strong peaks can be seen at 1.37v and disappeared in the following several cycles, which are usually ascribed to side reactions occurring at the electrode surfaces and interfaces due to the formation of the solid electrolyte mesophase (SEI) layer. Both stages produce irreversible lithium ion consumption with irreversible capacity, reducing the first cycle Coulomb efficiency of the composite material. The sharp peak centered below 0.05 V could be attributed to the formation of amorphous Li₁₅S₁₄ phase leading to huge volume expansion. In addition, an irreversible reaction occurred at the peak during the first cycle and an SEI layer was formed. Therefore, its intensity is much stronger than that during the consecutive cycle. The peak centered at 0.3 V and 0.52 V represents the delithiation process of the SNCNT composite. After the first cycle, it is necessary to specify that the CV curves are almost overlapped, and no new SEI film is produced during the charging and discharging processes. The results indicate excellent reversibility and superior stability of the silicon-nitrogen-doped carbon nanotubes.

FIG. 4B shows the discharge/charge profiles of the several cycles for the SNCNT electrode at a current density of 100 mAg⁻¹ between 0.01 and 3.0 V. The SNCNT composite has a flat discharge platform of 0.04V in the first cycle, as shown in FIG. 4B. It corresponds to the lithiated characteristic platform of crystalline Si, and indicates that Si experiences unevenness between its amorphous and crystalline phases and harmful volume changes. The SNCNT composite electrode shows first discharge (lithiation) and charge (delithiation) capacities of 1044 and 730 mAhg⁻¹, respectively. The corresponding Coulombic efficiency is low (˜71.0%), comparing to other four cycles (>90.0%). Moreover, the relatively low initial Coulombic efficiency can be ascribed to the irreversible capacity loss because of the formation of the SEI film and the decomposition of the electrolyte. This behavior may be due to the insufficient tightness of the composite material, resulting in an irreversible reaction leading to initial capacity loss. At the same time, it also demonstrates that one of the difficulties in composite research is the regulation of microstructure. After the first cycle, the SNCNT composite exhibits a gradual decrease in reversible capacity during the initial 10 cycles. However, for the SNCNT composite, excellent capacity retention can still be observed, as indicated by the fact that the voltage profile patterns remain quite similar over 100 cycles.

The cycling performance of the high-level N-doped and silicon-doped carbon nanofiber electrodes was evaluated at 100 mAg⁻¹ over a range of 0.01-3.0V versus Li/Li⁺ in a coin cell. As illustrated in FIG. 4C, the SNCNT electrode show excellent cyclic stability with a considerable capacity. The capacity of the SNCNT electrode decreased slightly during the first cycle and increased slightly during the subsequent cycles. This trend might be caused by the irreversible capacity loss due to the formation of an SEI layer. Nevertheless, the SNCNT electrode still show excellent cyclic stability. After 50 cycles, the electrode still maintained a discharge capacity of 453 mAhg⁻¹ with 62.7% capacity retention. The carbon nanotube material shows a higher specific capacity than the theoretical value of the carbon material (372 mAhg⁻¹) after compounding with nitrogen and silicon, which might be attributed to more and larger active potentials provided by nitrogen and silicon. The SNCNT composite exhibits excellent Li insertion and extraction capacities. In addition, many active potentials provide more favorable electronic pathway to facilitate the lithiation/delithiation processes among the composite particles. The Coulombic efficiency of lithium-ion batteries is approximately 100% as shown in FIG. 4C. This demonstrates that the discharge capacity of the lithium ion battery is almost equal to the charge capacity during the same cycle. In other words, the de-lithium capacity/lithium intercalation capacity of the SNCNT electrode material maintains a significantly good balance. It is further illustrated that the lithiation/delithiation processes of the SNCNT electrode material are quite perfect.

The rate performance of the SNCNT composite in FIG. 4D shows the excellent stability of the SNCNT composite anode material at various current densities. The capacity of the SNCNT composite electrode material is close to 100 mAhg⁻¹ at a current density of 5 C. When the current density returned to the initial 0.1 C, the specific capacity of the SNCNT composite material is returning back to the initial capacity value, indicating high reversibility.

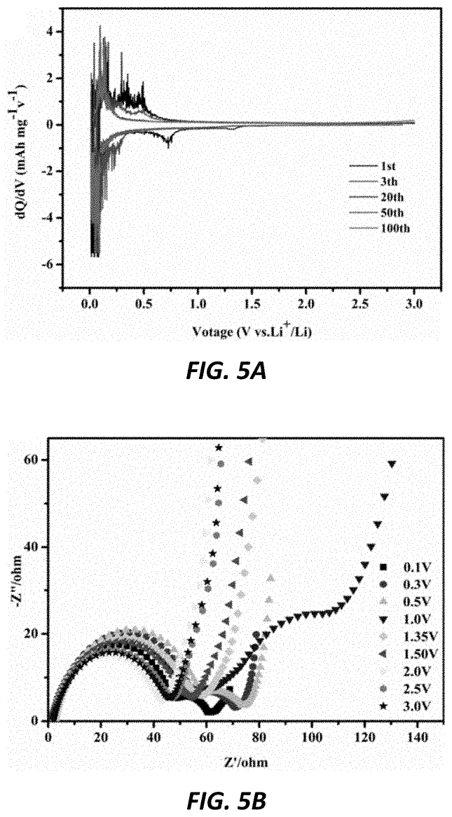

Furthermore, to better understand the reaction mechanism of SNCNT composite with Li, differential capacity plots of the SNCNT composite electrodes at various cycle numbers are presented, as shown in FIG. 5A. The large and broad peaks between 0.3 and 1.0 V are arising from the irreversible reaction of Li with the excess amount of carbon, which is expected to mainly contribute to the large capacity loss accompanied by SEI formation in the first cycle.

In order to better analyze the electron transport properties of SNCNT composites, electrochemical impedance spectroscopy (EIS) was obtained. As shown in FIG. 5B, between 1.35-3.0V, a semi-circular arc appears in the high-frequency region. It corresponds to the charge transfer resistance on electrode (Rct). while a straight line with a large slope in the low-mid frequency region corresponds to solid phase diffusion of the SNCNT composite electrode material. At lower potential, the semi-circular arc in the high frequency region represents the diffusion resistance of the electrolyte, but the small semicircular arc in the intermediate frequency region could be assigned to the resistance of the charge transfer on the electrolyte interface. The straight line in the low frequency region represents the resistance of the solid phase diffusion. Due to the formation of the SEI film^{[39]}, the half arc of the intermediate frequency region at 1.0 V becomes larger.

### Conclusion

In summary, the high silicon doping carbon nanotubes helps to enhance its chemical reactivity. Carbon nanotubes react with external atoms or molecules through doped silicon atoms, which is beneficial to improve the electrochemical reactivity of carbon nanotubes. The nitrogen-doped nanotubes have excellent electronic conductivity and high specific surface area. In addition, nitrogen doping in carbon nanotubes can promote the conductivity and insertion of Li ions. SNCNT exhibits excellent electrochemical performance, indicating that it should be considered as a potential candidate for anode materials for high performance lithium ion batteries. The work provides an effective way to achieve high levels of silicon doping in carbon nanotubes for energy storage.

### Example 2

### Preparation and Analysis of Exemplary Anode Materials

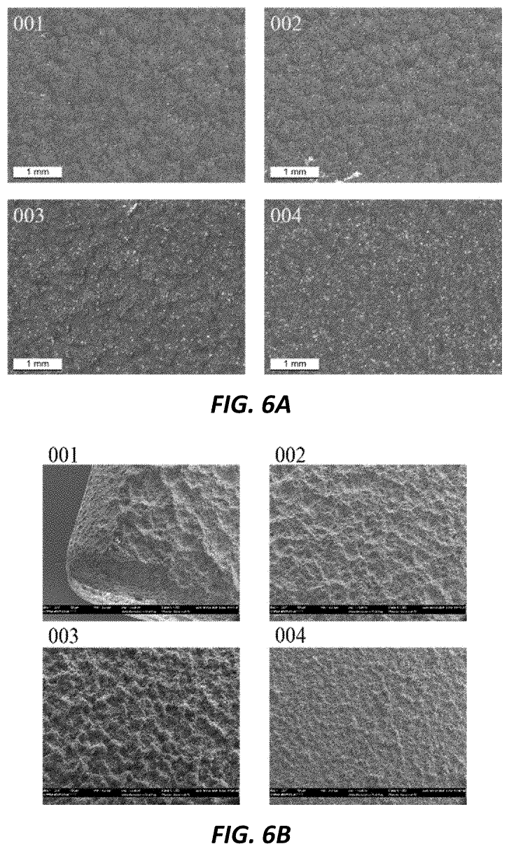

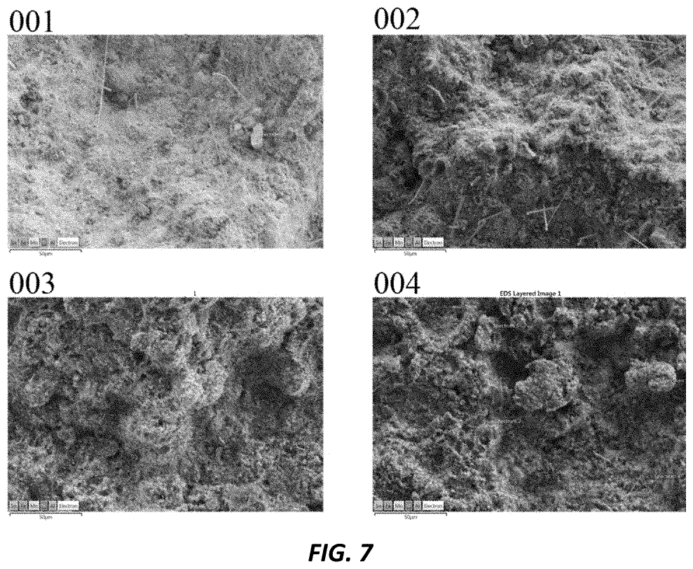

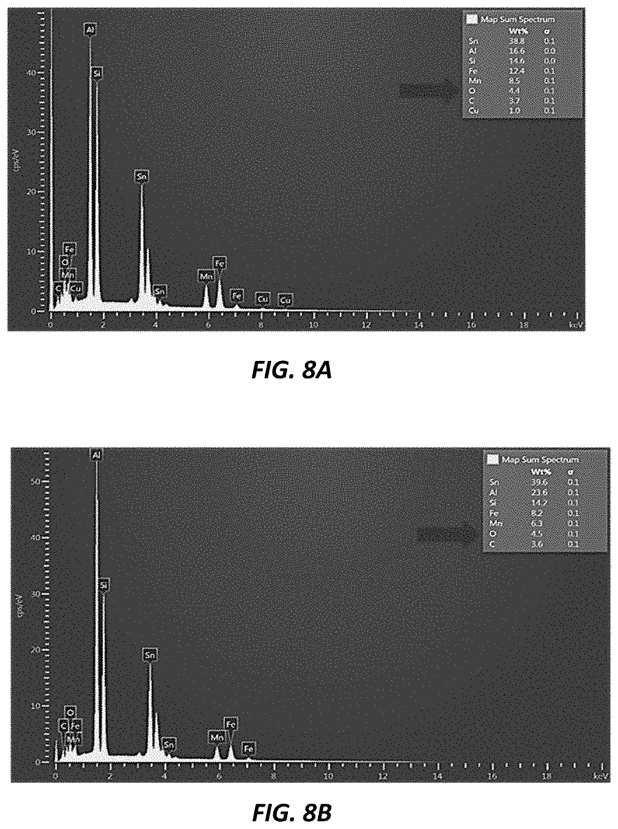

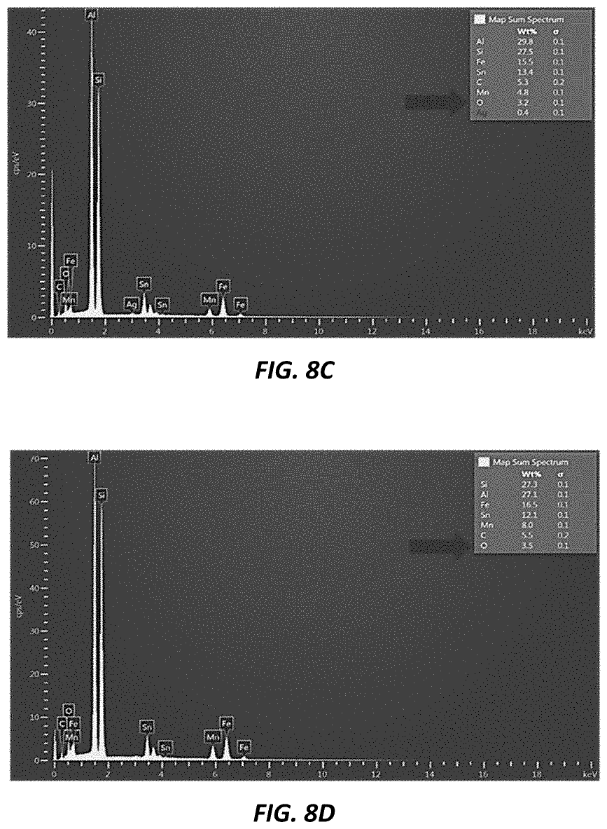

The feasibility of depositing Si-based alloy anodes was demonstrated, and the resulting anodes showed low (<5%) oxygen content and the Si element was finely dispersed throughout. Silicon is sensitive to air and moisture so the alloying elements for the Si-alloy based anode were blended in powder form (approximate size range 10 μm-50 μm) inside an inert gas (Argon) atmosphere glovebox, then sealed in argon-filled metallized polymer bags. The elements were silicon (chosen for its high current capacity (up to 3700 mAh/g)), iron, tin, aluminum (chosen for ductility and capacity properties), and manganese (also chosen for high battery performance potential). Silicon was not used alone for two reasons. First, it shrinks and swells up to four times its size during charge/discharge cycles, and it is brittle and thus unsuitable for cold spray deposition on its own. Blending elemental silicon with the materials listed above was done to address both issues. The resulting mixture was deposited using high-pressure cold spray equipment onto copper foil and analyzed. Four samples were prepared two with nitrogen as a carrier gas (Samples 001 and 002) and two with helium (Samples 003 and 004) as a carrier gas, which both led to homogeneous deposits (FIGS. 6A-6B) with low oxygen content. The samples which used helium as the carrier gas lead to deposits with slightly lower oxygen content than even those with nitrogen. The deposits on the four samples were examined closely for distribution of the silicon, shown in FIG. 7, and oxygen content, shown in FIGS. 8A-8D.

These SEM images show that the surfaces of sprayed films are quite good. The element distribution images indicate the samples are deposited with homogenous dispersion of the elements including silicon. Additionally, Samples 001-004 all had oxygen content that was very low (see, e.g., FIG. 8A-8D). Of these samples, Samples 003 and 004 showed the highest silicon amount and lowest oxygen percent in the EDX data (see FIGS. 8C and 8D). Further the element distribution data shows that the silicon was homogeneously dispersed in all areas. The sample was made by the helium gas at pressure: 525 psi (3.62 MPa) at temperature of 450° C.

The inventions being thus described, it will be obvious that the same may be varied in many ways. Such variations are not to be regarded as a departure from the spirit and scope of the inventions and all such modifications are intended to be included within the scope of the following claims.

The above specification provides a description of the manufacture and use of the disclosed compositions and methods. Since many embodiments can be made without departing from the spirit and scope of the invention, the invention resides in the claims.

What is claimed is:

1. A method of preparing an electrode material comprising:
depositing a doping material onto an electrode material; wherein the depositing is performed by cold spray and wherein the cold spray comprises a carrier gas; and wherein the doping material comprises hetero atoms, a silicon-based compound, or a mixture thereof

2. The method of claim 1, wherein the hetero atoms comprise N, P, S, B, O, F, Cl, Br, I, or a mixture thereof.

3. The method of claim 1, wherein the silicon-based compound comprises silicon, a silicon oxide, a silicon-alloy, or a mixture thereof.

4. The method of claim 1, wherein the doping material is a mixture of a silicon-based compound and hetero atoms; wherein the silicon-based compound comprises silicon, a silicon oxide, a silicon-alloy, or a mixture thereof; and wherein the hetero atoms comprise N, P, S, B, O, F, Cl, Br, I, or a mixture thereof.

5. The method of claim 1, doping material further comprises a lanthanide, gold, silver, copper, aluminum, cobalt, magnesium, zinc, vanadium, manganese, niobium, iron, nickel, titanium, zirconium, tin, scandium, yttrium, oxides thereof, alloys thereof, or a combinations thereof.

6. The method of claims 1, wherein the method comprises a step of dispersing the doping material; wherein the dispersing step is performed before the depositing step.

7. The method of claim 6, wherein the dispersing step comprises mixing the doping material with a surfactant, sonicating the doping material in a liquid medium, or both.

8. The method of claim 7, wherein the surfactant comprises a sulfonate group, a phosphate group, a quaternary ammonium group, an —OH group, an —COOH group, an —NH₂ group, an —SH₂ group, an —PhSO₃Na group, or a combination thereof

9. The method of claim 1, wherein the doping material comprises between about 0.01 wt. % and about 10 wt. % of the mass of the electrode material after deposition of the doping material.

10. The method of claim 1, wherein the carrier gas is helium or nitrogen.

11. The method of claim 1, wherein the carrier gas has a temperature of less than about 600° C.

12. The method of claim 1, wherein the carrier gas is at a pressure of between about 350 psi and about 750 psi.

13. An electrode material prepared according to the method of claim 1.

14. The electrode material of claim 13, wherein the doping material is a mixture of a silicon-based compound and hetero atoms; wherein the silicon-based compound comprises silicon, a silicon oxide, a silicon-alloy, or a mixture thereof; and wherein the hetero atoms comprise N, P, S, B, O, F, Cl, Br, I, or a mixture thereof

15. The electrode material of claim 14, wherein the doping material is homogenously dispersed on the electrode material.

16. The electrode material of claim 13, wherein the doping material further comprises a lanthanide, gold, silver, copper, aluminum, cobalt, magnesium, zinc, vanadium, manganese, niobium, iron, nickel, titanium, zirconium, tin, scandium, yttrium, oxides thereof, alloys thereof, or a combinations thereof.

17. A battery comprising:
an anode, a cathode, electrolyte, and a separator; wherein the anode and/or cathode comprise the electrode material of claim 13.

18. The battery of claim 17, wherein the doping material is a mixture of a silicon-based compound and hetero atoms; wherein the silicon-based compound comprises silicon, a silicon oxide, a silicon-alloy, or a mixture thereof; and wherein the hetero atoms comprise N, P, S, B, O, F, Cl, Br, I, or a mixture thereof

19. The battery of claim 18, wherein the doping material is homogenously dispersed on the electrode material.

20. The battery of claim 17, wherein the doping material further comprises a lanthanide, gold, silver, copper, aluminum, cobalt, magnesium, zinc, vanadium, manganese, niobium, iron, nickel, titanium, zirconium, tin, scandium, yttrium, oxides thereof, alloys thereof, or a combinations thereof.
